(19) United States
(12) Patent Application Publication
(10) Pub. No.: US 2024/0337297 A1
(43) Pub. Date: Oct. 10, 2024

(54) FLOCKED HELICAL SPRING AND METHOD FOR PRODUCING SAME

(71) Applicant: CHUO HATSUJO KABUSHIKI KAISHA, Nagoya-shi, Aichi (JP)

(72) Inventors: Seiki ITO, Nagoya-shi, Aichi (JP); Yasuhiko KUNITA, Nagoya-shi, Aichi (JP)

(73) Assignee: CHUO HATSUJO KABUSHIKI KAISHA, Nagoya-shi, Aichi (JP)

(21) Appl. No.: 18/546,566

(22) PCT Filed: Dec. 15, 2021
(86) PCT No.: PCT/JP2021/046257

§ 371 Date: Jan. 18, 2024

(30) Foreign Application Priority Data
Feb. 15, 2021 (JP) 2021-021657

(51) Int. Cl. F16F 1/02; B05D 1/00; B05D 1/16; B05D 3/10

(52) U.S. Cl. CPC F16F 1/024; B05D 1/007; B05D 1/16; B05D 3/102; F16F 2224/0241; F16F 2226/00; F16F 2226/02; F16F 2238/026

(57) ABSTRACT

The flocked helical spring includes a spring body, a cationic electrodeposition coating layer disposed on the surface of the spring body, an adhesive layer disposed on the surface of the cationic electrodeposition coating layer, and a flocking layer composed of flocking fillers fixed to the adhesive layer. The surface roughness Rz of the cationic electrodeposition coating layer is 19.6 μm or greater. The method for producing a flocked helical spring includes a cationic electrodeposition coating process of performing a cationic electrodeposition coating treatment on a spring body to form a film of an electrodeposition coating material on the surface of the spring body; an adhesive coating process of coating an adhesive containing a surface roughening solvent on the surface of the film; a flocking process of bonding flocking fillers to the surface coated with the adhesive; and a baking process of heating the spring body adhered with the flocking fillers.

### TECHNICAL FIELD

The present disclosure relates to a flocked spring on which coating and flocking are performed and a manufacturing method thereof.

### BACKGROUND ART

For example, a spring assembly for automatically opening and closing the tailgate is provided between the tailgate and the vehicle body, in an electric tailgate of an automobile. The spring assembly is in a telescopic cylindrical shape and is provided with a compression helical spring between the cover member at an outer side and the shaft member at an inner side. When the compression helical spring is compressed, sometimes a wave or helix “bend” occurs when the helical shaft is bent. When the part of the helical shaft is radially displaced due to bending, and abuts against the cover member provided at the outer side and the shaft member provided at the inner side in the compression helical spring, a knocking sound may be generated. As one countermeasure against such knocking sound, Patent Literature 1 describes the following method, that is, the surface of the compression helical spring is flocked by adhering short fibers, thereby having sound-reduction property.

### PRIOR ART LITERATURE

### Patent literature

Patent Literature 1: International Publication No. 2017/082252;

Patent Literature 2: JP2002-224612A;

Patent Literature 3: JPH5-138813A; and

Patent Literature 4: JPS61-164682A

### SUMMARY OF THE INVENTION

### Problems Intended to be Solved by the Present Disclosure

In the spring assembly, the compression helical spring provided between the cover member and the shaft member requires high dimensional accuracy in addition to sound reduction performance and anti-rust resistance. The inventors considers that a cationic electrodeposition coating is effective as a coating for endowing anti-rust resistance. According to the cationic electrodeposition coating, in addition to being able to form a coating film with excellent anti-rust resistance, chemical stability, and high mechanical strength, it is also easy to form a smooth coating film, and it is easy to manage the film thickness. When flocking the surface subjected to cationic electrodeposition coating, an adhesive for fixing short fibers is required. That is, as described in Patent Literatures 2 and 3, it is necessary to coat adhesive onto the to-be-flocked surface in advance and to fix short fibers thereon.

However, the surface subjected to the cationic electrodeposition coating is smooth, so if the adhesive is coated thereon, there is a problem that the adhesive is easily peeled off. If the adhesive is peeled off, the flocked short fibers will also fall off, and the desired sound-reduction effect may not be obtained.

The present disclosure has been made in view of such practical situations, and an object of the present disclosure is to provide a flocked spring whose adhesive layer is difficult to peel off and which has excellent durability, and a suitable manufacturing method thereof.

### Means of solving problems

(1) A flocked spring of the present disclosure includes: a spring body, a cationic electrodeposition coating layer provided on a surface of the spring body, an adhesive layer provided on a surface of the cationic electrodeposition coating layer, and a flocking layer composed of a flocking filler that is fixed to the adhesive layer, wherein a surface roughness (Rz: the maximum height) of the cationic electrodeposition coating layer provided with the adhesive layer is 19.6 μm or more.

(2) A manufacturing method of the flocked spring of the present disclosure is an example of the manufacturing method of the flocked spring having the structure of (1) above, including: a cationic electrodeposition coating process of performing a cationic electrodeposition coating treatment on the spring body, to form a coating film of electrodeposition coating material on the surface of the spring body; an adhesive coating process of coating the adhesive having a surface roughening solvent on the surface of the coating film; a flocking process of adhering the flocking filler to the surface coated with the adhesive; and a baking process of heating the spring body adhered with the flocking filler.

### Effects of the Present Disclosure

(1) The flocked spring of the present disclosure is provided with a cationic electrodeposition coating layer. Therefore, high anti-rust resistance and dimensional accuracy are satisfied. In addition, the surface roughness (Rz: maximum height) of the cationic electrodeposition coating layer that is provided with the adhesive layer is relatively large, which is 19.6 μm or more. Therefore, by using the anchor effect of the adhesive, the adhesion force between the cationic electrodeposition coating layer and the adhesive layer becomes larger, and the peeling of the adhesive layer is suppressed. As a result, the flocking layer is hard to fall off, and the sound reduction effect is maintained for a long time.

In addition, for a method for the decoration processing of the interior of the automobile body, Patent Literature 4 describes the following method, that is, the surface of the electrodeposition coating film formed by baking after the electrodeposition coating is coated with a synthetic resin adhesive, which is used as a counter electrode and electrostatically flocked with short fibers. However, in Patent Literature 4, there is neither description nor suggestion regarding the adhesive force of the adhesive, and there is also no description regarding the surface roughness of the electrodeposition coating film.

(2) In the manufacturing method of the flocked spring of the present disclosure, in the adhesive coating process, the adhesive having the surface roughening solvent is coated on the surface of the coating film formed by the cationic electrodeposition coating treatment. The so-called “surface roughening solvent” refers to a solvent that has a surface roughening effect of increasing the surface roughness of the cationic electrodeposition coating layer. The so-called “adhesive having a surface roughening solvent” includes adhesive of the following two cases, that is, the solvent component contained in the adhesive has a surface roughening effect, and the solvent has a surface roughening effect when the adhesive is diluted with a solvent and used. The surface roughness of the coating film of the electrodeposition coating material may be increased by coating an adhesive having a surface roughening solvent. Therefore, according to the manufacturing method of the flocked spring of the present disclosure, the desired surface roughness may be realized only by the process of coating the adhesive, without additionally adding a process of performing surface roughening treatment. Thereby, it is possible to reduce the number of processes, shorten the treatment time, and reduce the manufacturing cost. Thus, according to the manufacturing method of the present disclosure, the flocked spring, whose adhesive layer is difficult to peel off, whose flocking layer is difficult to fall off and which has excellent durability, may be manufactured easily at a low cost.

### BRIEF DESCRIPTION OF DRAWINGS

FIG. 1 is a partial schematic view of a spring assembly of a compression helical spring with a flocked spring provided by an embodiment of the present disclosure;

FIG. 2 is a sectional view of the compression helical spring in a radial direction;

FIG. 3 is a schematic view of a friction-wear test;

FIG. 4 is a graph showing measurement results of a surface withstand pressure with respect to surface roughness of a cationic electrodeposition coating layer in the case that an object member is a resin member.

FIG. 5 is a graph showing measurement results of the surface withstand pressure with respect to the surface roughness of the cationic electrodeposition coating layer in the case that the object member is a cationic electrodeposition coating member.

### DETAILED DESCRIPTION OF EMBODIMENTS

### Flocked Spring

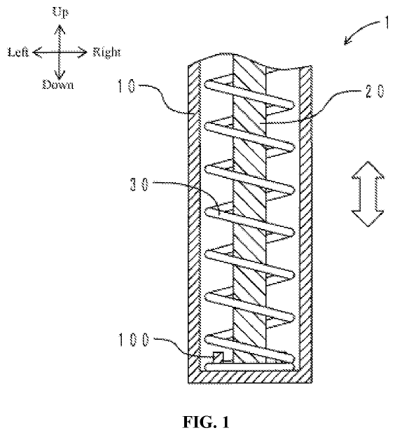

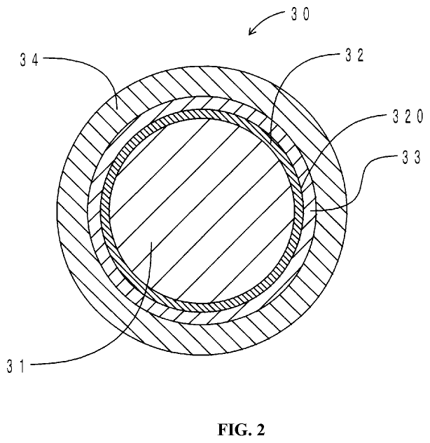

As one embodiment of the flocked spring of the present disclosure, the way of being used as a compression helical spring constituting a spring assembly is described. First, the structures of the spring assembly and the compression helical spring of the present embodiment are described. FIG. 1 is a partial schematic view of the spring assembly. FIG. 2 is a sectional view, in a radial direction, of the compression helical spring that is stored in the spring assembly. As shown in FIG. 1, a spring assembly 1 is provided with a cover member 10, a guide member 20, and a compression helical spring 30. The spring assembly 1 is used for the flip-up electric tailgate of the vehicle.

The cover member 10 is made of polyamide resin and is in a bottomed cylindrical shape with an opening facing upward. A spring seat 100 is disposed on the upper surface of the bottom wall of the cover member 10. The lower end of the cover member 10 is swingably mounted on the tailgate of the vehicle (not shown in the drawings). The guide member 20 is in a cylindrical shape, and is provided protruding upward from the upper surface of the bottom wall of the cover member 10. The guide member 20 is disposed at the inner side of the spring seat 100. The guide member 20 is made of iron, and its surface is subjected to cationic electrodeposition coating. The compression helical spring 30 is stored in the cover member 10. The compression helical spring 30 is provided such that a lower seat winding portion is mounted around the spring seat 100, with the guide member 20 as an axis.

As shown in FIG. 2, the compression helical spring 30 is provided with a spring body 31, a cationic electrodeposition coating layer 32, an adhesive layer 33, and a flocking layer 34 sequentially from inside. The spring body 31 is made of spring steel, and has a surface provided with a zinc phosphate film. The cationic electrodeposition coating layer 32 is disposed on the surface of the spring body 31. The cationic electrodeposition coating layer 32 contains an amine-modified epoxy resin and antirust pigment. The thickness of the cationic electrodeposition coating layer 32 is 25 μm. The surface roughness Rz of the surface 320 of the cationic electrodeposition coating layer 32 is 23 μm. The adhesive layer 33 is disposed on the surface 320 of the cationic electrodeposition coating layer 32. The adhesive layer 33 contains modified epoxy resin and antirust pigment. The thickness of the adhesive layer 33 is about 35-53 μm. As described later, a flocking filler is fixed on the adhesive layer 33. The thickness of the adhesive layer 33 is not constant due to the influence of the flocking filler, and the thickness of partial adhesive layer is about 1.5 times the thickness before the flocking. The flocking layer 34 is provided on the surface of the adhesive layer 33. The flocking layer 34 is composed of a flocking filler made of nylon 66 fiber. The flocking filler has a length of 800 μm, and has a part buried in the adhesive layer 33, and the other part protruding outward from the adhesive layer 33. The flocking layer 34 is formed of the other part of the flocking filler protruding from the adhesive layer 33. The compression helical spring 30 is included in the concept of the flocked spring of the present disclosure.

Next, the effects of the compression helical spring of the present embodiment will be described. According to the present embodiment, the compression helical spring 30 is provided with the cationic electrodeposition coating layer 32. According to the cationic electrodeposition coating, since the film thickness management is easy, the high dimensional accuracy required between the cover member 10 and the guide member 20 may be satisfied. The cationic electrodeposition coating layer 32 contains amine-modified epoxy resin and antirust pigment, and the adhesive layer 33 also contains modified epoxy resin and antirust pigment. Therefore, the compression helical spring 30 has high anti-rust resistance. The compression helical spring 30 is provided with the flocking layer 34 on the outermost layer. Even if the compression helical spring 30 bends to abuts against the cover member 10 and the guide member 20, the energy at the time of collision is absorbed by the flocking layer 34, so the knocking sound generated is small. The surface roughness Rz of the cationic electrodeposition coating layer 32 in contact with the adhesive layer 33 is large. Therefore, by using the anchor effect of the adhesive layer 33, the adhesion force between the cationic electrodeposition coating layer 32 and the adhesive layer 33 is increased, and the adhesive layer 33 is difficult to peel off. As a result, the flocking layer 34 is hard to fall off, and the sound reduction effect is maintained for a long time.

As mentioned above, one embodiment of the flocked spring of the present disclosure is described, however, the flocked spring of the present disclosure is not limited to such embodiment and may be implemented in various ways such as changes, improvements, etc., that a person skilled in the art may made, within the scope of the subject matter of the present disclosure.

### Spring Body

The type of the spring body is not limited to helical spring, leaf spring, coil spring, and torsion bar, etc. As a material of the spring body, spring steel used for the spring is generally preferred, and examples thereof include carbon steel, alloy steel, stainless steel, etc. In the spring body, for example, after performing hot-forming or cold-forming on the spring steel, etc., it is only necessary to perform shot peening, etc., to adjust the surface roughness in advance. In addition, it is preferable to form a film of phosphates such as zinc phosphate or iron phosphate on the base surface of the spring body. By forming the cationic electrodeposition coating layer on the phosphate film, the corrosion resistance is improved, and the adhesion of the cationic electrodeposition coating layer is also improved. In particular, when the phosphate is zinc phosphate, the corrosion resistance is further improved. The phosphate film may be formed by a known method. For example, an immersion method in which the spring body is dipped in a phosphate solution tank, a spray method in which a phosphate solution is sprayed onto the spring body with a spray gun, etc. may be illustrated.

### Cationic Electrodeposition Coating Layer

The cationic electrodeposition coating layer is provided on the surface of the spring body. The cationic electrodeposition coating layer is a layer formed by immersing the spring body in a predetermined electrodeposition coating material, and applying a voltage between an anode and the spring body used as a cathode. The components of the electrodeposition coating material are not particularly limited. The electrodeposition coating material includes base resins, curing agents, pigments, and the like.

As the base resin, amine-modified epoxy resin is preferable from the viewpoint of improving anti-rust resistance. The curing agent may be appropriately used depending on the base resin, and examples thereof include blocked isocyanate and the like. In the case of using amine-modified epoxy resin as the base resin, a curing catalyst may also be used. Examples of the curing catalyst may include organotin compounds such as dibutyltin oxide, dibutyltin dilaurate, and dioctyltin. The pigment includes coloring pigment, extender pigment, antirust pigment, and the like. Examples of the coloring pigment include inorganic pigment such as carbon black, titanium dioxide, Bengala, and loess, etc.; and organic pigment such as quinacridone red, phthalocyanine blue, and benzidine yellow, etc. Examples of the extender pigment include aluminum silicate, calcium carbonate, magnesium carbonate, talc, silica, barium sulfate, and the like. Examples of the antirust pigment include iron phosphate, aluminum phosphate, calcium phosphate, and the like. The electrodeposition coating material may also contain various additives as necessary, in addition to these components. Examples of the additives include surface conditioning agents, ultraviolet absorbers, antioxidants, charged inhibitors, flame retardants, and the like.

The thickness of the cationic electrodeposition coating layer may be appropriately determined in consideration of the mechanical strength, the anti-rust performance, and the required size of the flocked spring, etc. In order to fully exhibit desired performance, the thickness is preferably 10 μm or more, and more preferably, the thickness is 15 μm or more. On the other hand, from the viewpoint of design robustness, the thickness is preferably 30 μm or less, and more preferably the thickness is 25 μm or less.

The surface roughness (Rz: maximum height) of the cationic electrodeposition coating layer provided with the adhesive layer is 19.6 μm or more. Since the surface roughness is large, the adhesion force to the adhesive layer is increased through the anchor effect. The surface roughness of the cationic electrodeposition coating layer in the present disclosure is the maximum height roughness specified in JISB0601-2013. The lower limit value 19.6 of the surface roughness Rz includes the case where the second decimal place is rounded up to 19.6.

### Adhesive Layer

The adhesive layer is provided on the surface of the cationic electrodeposition coating layer. The adhesive layer is a layer formed by coating an adhesive and drying it. Adhesives may be solvent-based or emulsion-based, for example, examples thereof include an adhesive containing, as main components, epoxy resin, urethane resin, acrylic resin, vinyl acetate resin, polyimide resin, and silicone resin, etc. The adhesive may be appropriately selected in consideration of the adhesiveness of the cationic electrodeposition coating layer to the base resin. Among them, a solvent-based adhesive containing modified epoxy resin as the main components has high anti-rust resistance and may be used as a one-component coating, and thus is preferable.

The adhesive may further contain pigments, solvents, and additives, in addition to resin components. The pigment includes coloring pigment, extender pigment, antirust pigment, etc., similar to the aforementioned electrodeposition coating material. Examples of the additives include surface conditioning agent, ultraviolet absorber, antioxidant, charged inhibitor, flame retardant, and the like.

From the viewpoint of easy adjustment of the surface roughness of the cationic electrodeposition coating layer, the adhesive layer is preferably formed by coating an adhesive having a surface roughening solvent. For the surface roughening solvent, the surface roughness before coating the adhesive and the surface roughness after the coating and drying (hereinafter, sometimes referred to as “after coating” for short) are compared, and the solvent whose surface roughness after coating is 2 times the surface roughness before coating is preferable, more preferably, 3 times or more.

A flocking filler is fixed on the adhesive layer. The thickness of the adhesive layer is not constant due to the influence of the flocking filler. For example, after flocking, there are parts whose thickness becomes about 1.5 times the thickness before flocking. The thickness of the adhesive layer is not particularly limited as long as the flocking filler may be fixed. For the thickness before flocking, the thickness is preferably 20 μm or more, and the thickness is more preferably 25 μm or more. In another aspect, from the viewpoint of design robustness, the thickness is preferably 50 μm or less, and the thickness is more preferably 45 μm or less.

### Flocking Layer

The flocking layer consists of a flocking filler fixed to the adhesive layer. A part of the flocking filler is buried in the adhesive layer, and the other part thereof protrudes outward from the adhesive layer. The flocking layer is formed by the other part of the flocking filler protruding from the adhesive layer.

The type of the flocking filler (hereinafter, sometimes referred to as “filler” for short) is not particularly limited, and it may be an organic filler or an inorganic filler. Compared with the inorganic fillers, organic fillers are soft, and thus is difficult to break during adhering and easy to maintain the flocking state. Examples of organic fillers include, for example, nylon fibers, polyester fibers, rayon fibers, cotton fibers, polyethylene fibers, aramid fibers, and fluorine fibers, etc. Among them, it is preferable to contain one or more fibers selected from nylon fibers, polyester fibers, rayon fibers, cotton fibers, and polyethylene fibers. Examples of the inorganic fillers include glass fiber and the like.

The surface resistance value of the flocking filler is preferably equal to or greater than 1×10⁵Ω and less than 1×10¹⁸Ω. In the present specification, for the surface resistance value, a value measured by a super insulation meter “SM-8220” manufactured by Hioki Electric Co., Ltd. is used. When the surface resistance value of the flocking filler is less than 1×10⁵Ω, the electrical conductivity is high and discharge becomes easy, so the scattering property of the filler deteriorates. Therefore, flocking by using electrostatic force becomes difficult. A more preferable surface resistance value is 1×10¹⁸Ω or more. On the contrary, when the surface resistance value is 1×10¹⁸Ω or more, the scattering property of the filler is deteriorated due to too much charge. Therefore, flocking by using electrostatic force becomes difficult. A more preferable surface resistance value is less than 1×10¹⁷Ω, and further less than 1×10¹¹Ω.

For the flocking filler, in order to improve dispersibility and inhibit excessive charge, the fibers subjected to various surface treatments such as electrodeposition treatment, water absorption treatment, waterproof treatment, and primer treatment, etc. may be used. For example, the flocking filler is preferably provided with an electrodeposition treatment film on the surface thereof. By providing the electrodeposition treatment film, the surface resistance value of the filler is adjusted to the desired value. Thus, excessive charge of the filler is inhibited and the flying force during flocking is improved. In addition, because the fibers are easy to agglomerate, they are easy to be directly entangled to become agglomerates. For this point, if there is an electrodeposition treatment film on the surface, the dispersibility of the fibers (flocking filler) is improved. As a result, the agglomeration of the filler may be inhibited, achieving a roughly uniform flocking state.

The electrodeposition treatment film is formed by performing electrodeposition treatment on the surfaces of the fibers used as the flocking fillers. For the electrodeposition treatment, there is a method in which fibers are treated with tannin, tartar emetic, etc. to generate tannin compounds, etc. on the surfaces of the fibers. In addition, there is a method in which the fibers are treated by using a solution to make a silicon-based compound adhered to the surfaces of the fibers, wherein in the solution, inorganic salts such as barium chloride, magnesium sulfate, sodium silicate, and sodium sulfate, surfactants such as quaternary ammonium salts, higher alcohol sulfate ester salts and betaines, and organic silicon compounds (colloidal silicon dioxide) are appropriately mixed.

The flocking filler is fibrous. The length of the filler in the long-side direction is not particularly limited, but if the filler is too short, the filler will be buried in the adhesive layer and the desired flocking state may not be achieved. For example, the length of the filler is preferably 50 μm or more, preferably 200 μm or more, and further preferably 500 μm or more. On the other hand, if the filler is too long, the filler may fall down and thus the desired flocking state may not be achieved. For example, the length of the filler is preferably 2,000 μm or less, more preferably 1,000 μm or less, and further preferably 600 μm or less. The maximum length (thickness) of the filler in the short-side direction is not particularly limited, but if the filler is too thin, it will curl due to its own weight, and the desired flocking state may not be achieved. For example, the thickness of the filler is preferably 5 μm or more, more preferably 10 μm or more, and further preferably 20 μm or more. On the other hand, if the filler is too thick, the touch feeling may deteriorate. For example, the thickness of the filler is preferably 50 μm or less, more preferably 40 μm or less, and further preferably 30 μm or less.

The flocking filler may be not only planted in an upright state with respect to the surface of the spring body, but also be planted in an inclined state with respect to the surface of the spring body. When the planted flocking fillers intersect with each other, it is considered that the amount of energy absorbed by the flocking layer increases, improving the sound reduction performance. The adhesion amount of the flocking fillers does not have to be constant on the whole flocked spring. For example, the adhesion amount may be increased on the surface in contact with the object member, and the adhesion amount may be decreased on the surface that is not in contact with the object member. The adhesion amount of the flocking fillers for the surface in contact with the object member may be equal to or greater than 1.2 mg/cm² and equal to or less than 80 mg/cm². When the adhesion amount of the flocking fillers is less than 1.2 mg/cm², not only is it difficult to be manufactured, but also the effect such as sound reduction obtained by flocking is also reduced due to less fillers, the adhesion amount is preferably 2 mg/cm² or more. On the other hand, even if the adhesion amount of the fillers is greater than 80 mg/cm², no difference is seen in the effect obtained. Considering the manufacturing cost, the adhesion amount of the flocking fillers may be 18 mg/cm² or less. In order to ensure the sound reduction performance and further reduce the manufacturing costs, the adhesion amount may be 10 mg/cm² or less.

### Manufacturing Method for the Flocked Spring

The manufacturing method of the flocked spring of the present disclosure is not particularly limited, but according to the following manufacturing method, the flocked spring of the present disclosure may be manufactured easily and at a low cost. The manufacturing method of the flocked spring of the present disclosure includes a cationic electrodeposition coating process, an adhesive coating process, a flocking process, and a baking process.

### Cationic Electrodeposition Coating Process

The present process is a process of performing a cationic electrodeposition coating process on the spring body, to form a coating film of electrodeposition coating material on the surface of the spring body. The cationic electrodeposition coating process may be performed by a known method. That is, the spring body is immersed in a predetermined electrodeposition coating material, and a voltage is applied between an anode and the spring body that is used as a cathode. For the electrodeposition coating material, as previously described, as coating conditions, the temperature of the electrodeposition coating material may be 25-35° C., and the applied voltage may be 40-400V. The coating film of the electrodeposition coating material may be formed such that the thickness of the cationic electrodeposition coating layer is equal to or greater than 10 μm and equal to or less than 30 μm.

In addition, the manufacturing method of the flocked spring of the present disclosure may include, before the present process, processes (pretreatment processes) of adjusting, on the spring body, the surface roughness by shot peening or the like, and forming a phosphate film.

### Adhesive Coating Process

The present process is a process of coating an adhesive having a surface roughening solvent on the surface of the coating film formed by the cationic electrodeposition coating treatment. As mentioned above, the so-called “adhesive having a surface roughening solvent” includes adhesives of following two cases, that is, the solvent component contained in the adhesive has a surface roughening effect, and the solvent has a surface roughening effect when the adhesive is diluted with a solvent and used. By using the adhesive with a surface roughening solvent, the desired surface roughness may be achieved, without additionally adding a process of performing surface roughening treatment. For the adhesive, as mentioned above, the coating of the adhesive may be performed by using a sprayer, etc. The adhesive may be coated such that the thickness of the adhesive layer in a non-flocked state is equal to or greater than 20 μm and equal to or less than 50 μm.

### Flocking Process

The present process is a process of adhering the flocking fillers to the surface coated with the adhesive. For the flocking fillers, as mentioned before, the flocking fillers may be adhered by using an electrostatic coating gun, an electrostatic flow immersing tank, etc. In the former case, the flocking fillers are made to pass through the nozzle of the electrostatic coating gun to make the flocking fillers charged, and adhered to the adhesive coating surface of the spring body. As long as the flocking filler is capable of being charged, it is acceptable to apply a voltage or not apply a voltage to the nozzle of the electrostatic coating gun. In the latter case, the flocking fillers are made to be charged by using a needle-shaped discharge electrode applied with a voltage, while flowing in the electrostatic flow immersing tank, and adhered to the adhesive coating surface of the spring body.

### Baking Process

The present process is a process of heating the spring body adhered with the flocking fillers. The heating may be performed by using a generally used electric furnace, a hot air dryer, or the like. Through this process, the coating film of the electrodeposition coating material and the adhesive coated are cured to form the cationic electrodeposition coating layer and the adhesive layer. The heating temperature, the heating time, etc. may be appropriately determined according to the types of the electrodeposition coating material and the adhesive. For example, the heating temperature may be 150-190° C., and the heating time may be 10-40 minutes.

### Embodiments

Next, the present disclosure will be described more specifically with reference to the embodiments.

### Manufacturing of Samples

First, a hollow cylindrical base material made of carbon steel (S55C) and having an outer diameter of 26 mm, an inner diameter of 20 mm, and a length of 15 mm was prepared, and as a pretreatment, a zinc phosphate film was formed on the surface. Next, the base material was immersed in the electrodeposition coating material, and the base material was used as a cathode to perform a cationic electrodeposition coating treatment to form a coating film of the electrodeposition coating material on the surface of the base material. In Table 1 below, the components of the electrodeposition coating material used are shown. After that, the adhesive diluted with a solvent was sprayed with a sprayer onto the coating film formation surface on the inner peripheral side of the base material, to obtain the target thickness of 35 μm. In Table 2 below, the components of the used adhesive (excluding the solvent for dilution) are shown. The dilution rate of the sprayed adhesive is 30% (100 parts by mass of solvent for dilution: 30 parts by mass of adhesive). Next, the flocking fillers are electrostatically adsorbed to the adhesive coating surface. As the flocking fillers, nylon 66 fibers (thickness of 20 μm, length of 800 μm, having an electrodeposition treatment film, and surface resistance value of 1010-1013 (2) were used. Finally, the base material adhered with the flocking filler was placed in the hot air dryer and heated at 150° C. for 10 minutes to bake the electrodeposition coating material and the adhesive. In this way, a sample in which a cationic electrodeposition coating layer, an adhesive layer, and a flocking layer are sequentially formed on the inner peripheral surface of the cylindrical base material from the bottom is manufactured. The thickness of the electrodeposition coating layer in the obtained sample is 20 μm, and the adhesion amount of the flocking fillers is 3 mg/cm².

TABLE 1

| Components of Electrodeposition | |
|---|---|
| Coating Material | Blending ratio (mass %) |
| Amine-modified epoxy resin | 81.5 |
| Coloring pigment (carbon black) | 1.6 |
| Extender pigment (aluminum silicate) | 15.6 |
| Antirust pigment | 1.0 |
| Curing catalyst (dibutyltin oxide) | 0.3 |

TABLE 2

| Components of Adhesive | Blending ratio (mass %) |
|---|---|
| Modified epoxy resin | 16 |
| Coloring pigment, extender pigment, | 30 |
| antirust pigment | |
| Solvent | 53 |
| Additive | 1 |

In the present embodiment, two kinds of solvents A and B having a surface roughening effect were prepared as the solvents for dilution of the adhesive. Then, five samples were manufactured by using the surface roughening solvent A, and five samples were manufactured by using the surface roughening solvent B. Here, the “adhesives diluted with the surface roughening solvents A, B” are included in the concept of “adhesive having the surface roughening solvent” of the present disclosure. In addition, two types of samples were manufactured by using a commercially available solvent C (manufactured by Shinto Paint Co., Ltd., “MSP diluting agent”) not having a surface roughening effect, as a solvent for dilution of the adhesive. Table 3 shows the surface roughness (Rz) of the cationic electrodeposition coating layer before and after coating the adhesive in each of the samples. The surface roughness of the cationic electrodeposition coating layer was measured by using a shape analysis laser microscope (“VK9710” manufactured by KEYENCE Co., Ltd.) conforming to JISB0601: 2013 after the adhesive was coated and dried at room temperature.

TABLE 3

| | | Surface Roughening Solvent A | | | | | Surface Roughening Solvent B | | | | | Solvent C | |
|---|---|---|---|---|---|---|---|---|---|---|---|---|---|
| Surface | Before | 5.00 | 6.00 | 4.00 | 4.00 | 6.00 | 6.44 | 8.58 | 5.23 | 5.43 | 3.56 | 5.36 | 3.00 |
| Roughness | Coating | | | | | | | | | | | | |
| Rz (mm) | Adhesive | | | | | | | | | | | | |
| | After | 19.00 | 23.00 | 18.00 | 22.00 | 17.00 | 22.46 | 26.62 | 22.32 | 22.89 | 19.58 | 8.85 | 3.56 |
| | Coating | | | | | | | | | | | | |
| | Adhesive | | | | | | | | | | | | |
| Surface | With | 13.80 | 14.88 | 12.50 | 17.30 | 12.50 | 18.00 | 18.50 | 17.20 | 16.40 | 17.60 | 8.50 | 5.50 |
| Withstand | Respect To | | | | | | | | | | | | |
| Pressure | Resin | | | | | | | | | | | | |
| (MPa) | Member | | | | | | | | | | | | |
| | With | 1.80 | 3.50 | 1.0 | 3.40 | 0.25 | 3.50 | 3.81 | 3.76 | 4.13 | 3.08 | 0.20 | 0.10 |
| | Respect To | | | | | | | | | | | | |
| | Cationic | | | | | | | | | | | | |
| | Electro- | | | | | | | | | | | | |
| | deposition | | | | | | | | | | | | |
| | Coating | | | | | | | | | | | | |
| | member | | | | | | | | | | | | |

### Evaluation of the adhesiveness of the adhesive layer

### Test Method

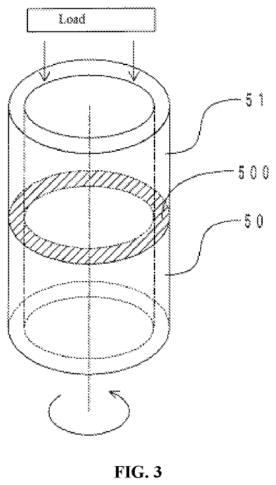

The surface withstand pressure was determined by performing a friction-wear test on the manufactured sample, to thereby evaluate the adhesiveness of the adhesive layer. The friction-wear test was performed by using the friction and wear test apparatus “EFM-3-1010” made by ORIENTEC in accordance with the method A of JISK7218: 1986. FIG. 3 shows an schematic view of the friction-wear test. As shown in FIG. 3, in the friction-wear test, a hollow cylindrical object member 51 having the same size as the base material of a hollow cylindrical sample 50 was stacked on the sample 50, and the sample 50 was rotated while a specified load was applied over the object member 51. Then, the coefficient of friction between the sliding surface 500 of the sample 50 (the upper-end surface of the sample 50, in FIG. 3, represented as the hatching part) and the object member 51 was measured, and the time point when the coefficient of friction suddenly increases is regarded as the time point when the adhesive layer of the sample 50 is peeled off, and the surface pressure on the sliding surface at that time point is regarded as the surface withstand pressure. The greater the surface withstand pressure is, the harder it is for the adhesive layer to peel off, which means that the adhesion force of the adhesive layer is large.

Two kinds of the friction-wear test were performed by changing the object member, the first test is performed by using a resin member made of polyamide resin as the object member, and the second test is performed by using, as the object member, a cationic electrodeposition coating member obtained by performing cationic electrodeposition coating on an iron base material. The resin member corresponds to the cover member 10 disposed at the outer side of the helical spring 30 in FIG. 1 above, and the cationic electrodeposition coating member corresponds to the guide member 20 disposed at the inner side of the helical spring 30. In the first test, at room temperature, a load is applied such that the surface pressure of the sliding surface increases by 0.5 MPa per minute, and the sample is rotated at a speed of 15 mm/sec. In the second test, at room temperature, a load is applied such that the surface pressure of the sliding surface increases by 0.125 MPa every 0.5 minutes, and the sample is rotated at a speed of 15 mm/sec.

### Evaluation Results

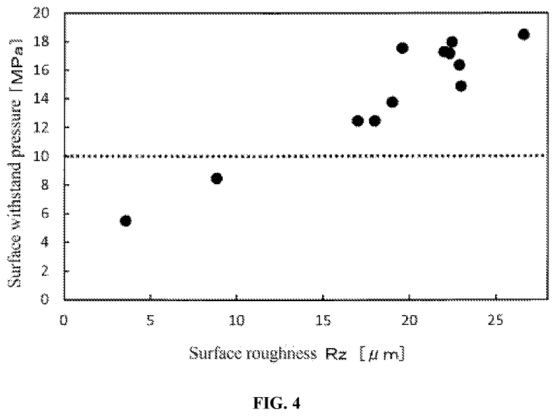

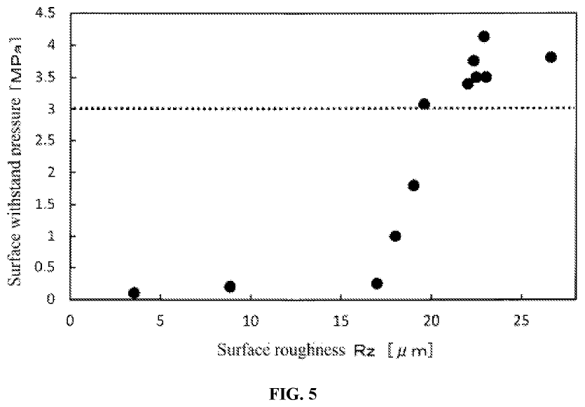

FIG. 4 and FIG. 5 show the measurement results of the surface withstand pressure with respect to the surface roughness of the cationic electrodeposition coating layer in each of the samples. FIG. 4 shows the results of the first test in which the object member is a resin member, and FIG. 5 shows the results of the second test in which the object member is a cationic electrodeposition coating member. As shown by the dotted line in FIG. 4, in the case that the object member is a resin member, if the surface withstand pressure is 10.00 MPA or more, it is determined that the adhesiveness is good. As shown by the dotted line in FIG. 5, in the case that the object member is a cationic electrodeposition coating member, if the surface withstand pressure is 3.00 MPA or more, it is determined that the adhesiveness is good. As shown in FIG. 4 and FIG. 5, regardless of whether the object member is a resin member or a cationic electrodeposition coating layer, when the surface roughness of the cationic electrodeposition coating layer of the sample is 19.6 or higher, the satisfactory adhesiveness may be obtained, and it confirms that the adhesive layer is difficult to peel off.

### REFERENCE SIGNS FOR THE DRAWINGS

1: spring assembly, 10: cover member, 100: spring seat, 20: guide member, 30: compression helical spring (flocked spring), 31: spring body, 32: cationic electrodeposition coating layer, 320: surface of the cationic electrodeposition coating layer, 33: adhesive layer, 34: flocking layer, 50: sample, 500: sliding surface, 51: object member.

1. A flocked helical spring, comprising:
a spring body;
a cationic electrodeposition coating layer, provided on a surface of the spring body;
an adhesive layer, provided on a surface of the cationic electrodeposition coating layer; and
a flocking layer, composed of a flocking filler that is fixed to the adhesive layer,
wherein a surface maxiumim height roughness of the cationic electrodeposition coating layer provided with the adhesive layer is 19.6 μm or more.

2. The flocked helical spring according to claim 1, wherein the adhesive layer is formed by coating an adhesive containing a surface roughening solvent.

3. The flocked helical spring according to claim 1, wherein the adhesive layer contains a modified epoxy resin and an antirust pigment, and the cationic electrodeposition coating layer contains and amine-modified epoxy resin and an antirust pigment.

4-6. (Canceled)

7. The flocked helical spring according to claim 1, wherein the flocking filler contains one or more fibers selected from the group consisting of nylon fibers, polyester fibers, rayon fibers, cotton fibers, and polyethylene fibers.

8. (canceled)

9. A manufacturing method for a flocked helical spring, for manufacturing the flocked helical spring according to claim 1, wherein the manufacturing method for the flocked helical spring comprises:
a cationic electrodeposition coating process of performing a cationic electrodeposition coating treatment on the spring body, to form a coating film of an electrodeposition coating material on the surface of the spring body;
an adhesive coating process of coating the adhesive having a surface roughening solvent on a surface of the coating film;
a flocking process of adhering the flocking filler to the surface coated with the adhesive; and
a baking process of heating the spring body adhered with the flocking filler.

10. The flocked helical spring according to claim 2, wherein the adhesive layer contains a modified epoxy resin and an antirust pigment, and the cationic electrodeposition coating layer contains an amine-modified epoxy resin and an antirust pigment.

11. The flocked helical spring according to claim 2, wherein the flocking filler contains one or more fibers selected from the group consisting of nylon fibers, polyester fibers, rayon fibers, cotton fibers, and polyethylene fibers.

12. The flocked helical spring according to claim 3, wherein the flocking filler contains one or more fibers selected from the group consisting of nylon fibers, polyester fibers, rayon fibers, cotton fibers, and polyethylene fibers.

13. The flocked helical spring according to claim 1, wherein the adhesive layer contains a modified epoxy resin and an antirust pigment, the cationic electrodeposition coating layer contains an amine-modified epoxy resin and an antirust pigment, and the flocking filler contains one or more fibers selected from the group consisting of nylon fibers, polyester fibers, rayon fibers, cotton fibers, and polyethylene fibers.

14. The flocked helical spring according to claim 2, wherein the adhesive layer contains a modified epoxy resin and an antirust pigment, the cationic electrodeposition coating layer contains an amine-modified epoxy resin and an antirust pigment, and the flocking filler contains one or more fibers selected from the group consisting of nylon fibers, polyester fibers, rayon fibers, cotton fibers, and polyethylene fibers.

15. The manufacturing method according to claim 9, wherein the adhesive layer is formed by coating an adhesive containing a surface roughening solvent.

16. The manufacturing method according to claim 9, wherein the adhesive layer contains a modified epoxy resin and an antirust pigment, and the cationic electrodeposition coating layer contains an amine-modified epoxy resin and an antirust pigment.

17. The manufacturing method according to claim 9, wherein the flocking filler contains one or more fibers selected from the group consisting of nylon fibers, polyester fibers, rayon fibers, cotton fibers, and polyethylene fibers.

18. The manufacturing method according to claim 15, wherein the adhesive layer contains a modified epoxy resin and an antirust pigment, and the cationic electrodeposition coating layer contains an amine-modified epoxy resin and an antirust pigment.

19. The manufacturing method according to claim 15, wherein the flocking filler contains one or more fibers selected from the group consisting of nylon fibers, polyester fibers, rayon fibers, cotton fibers, and polyethylene fibers.

20. The manufacturing method according to claim 16, wherein the flocking filler contains one or more fibers selected from the group consisting of nylon fibers, polyester fibers, rayon fibers, cotton fibers, and polyethylene fibers.

21. The manufacturing method according to claim 9, wherein the adhesive layer contains a modified epoxy resin and an antirust pigment, the cationic electrodeposition coating layer contains an amine-modified epoxy resin and an antirust pigment, and the flocking filler contains one or more fibers selected from the group consisting of nylon fibers, polyester fibers, rayon fibers, cotton fibers, and polyethylene fibers.

22. The manufacturing method according to claim 15, wherein the adhesive layer contains a modified epoxy resin and an antirust pigment, the cationic electrodeposition coating layer contains an amine-modified epoxy resin and an antirust pigment, and the flocking filler contains one or more fibers selected from the group consisting of nylon fibers, polyester fibers, rayon fibers, cotton fibers, and polyethylene fibers.
